(19) United States
(12) Patent Application Publication
(10) Pub. No.: US 2024/0227084 A1
(43) Pub. Date: Jul. 11, 2024

(54) METHOD FOR DIVIDING WORKPIECES COMPOSED OF BRITTLE-HARD MATERIALS AND ELEMENTS PRODUCIBLE BY THE METHOD

(71) Applicant: Schott AG, Mainz (DE)

(72) Inventors: Fabian Wagner, Mainz (DE); Matthias Jotz, Mainz (DE); Andreas Ortner, Mainz (DE); Renè Liebers, Mittweida (DE); Christopher Mauer, Ellefeld (DE); Pascal Schumacher, Mühlau (DE)

(73) Assignee: Schott AG, Mainz (DE)

(21) Appl. No.: 18/409,364

(22) Filed: Jan. 10, 2024

(30) Foreign Application Priority Data
Jan. 11, 2023 (DE) 10 2023 100 535.9

(51) Int. Cl. B23K 26/53; B23K 26/06; B23K 26/0622; B23K 26/40

(52) U.S. Cl. CPC B23K 26/53; B23K 26/0624; B23K 26/0648; B23K 26/40; B23K 2103/54

(57) ABSTRACT

A method for dividing a workpiece into elements includes: a pulsed laser beam of an ultrashort pulse laser is directed onto a workpiece composed of brittle-hard material; instances of filamentary damage are introduced next to one another along a path. The distance between the instances of filamentary damage at least in one portion of the path is selected such that one of the following conditions is met: (i) the difference in terms of magnitude between the characteristic fracture strengths of the element upon bending in opposite directions in this portion is at most 10 MPa; (ii) the difference in terms of magnitude between the characteristic fracture strengths of the element upon bending in opposite directions in this portion is at least 30 MPa; and (iii) the difference in terms of magnitude between the fracture strengths upon bending of the element in opposite directions is at least 30 MPa*d[mm]*π/3.

### CROSS REFERENCE TO RELATED APPLICATIONS

This claims priority to German patent application no. 10 2023 100 535.9, filed Jan. 11, 2023, which is incorporated herein by reference.

### BACKGROUND OF THE INVENTION

### 1. Field of the Invention

The present invention relates to a method for dividing workpieces into elements.

### 2. Description of the Related Art

One method, which is known for example from WO 2018/122112 A1, is based on using a pulsed focused laser beam to introduce instances of damage into the workpiece. These instances of damage are introduced next to one another along an intended path. The workpiece is weakened by the instances of damage along the path and can then be easily separated there by application of a mechanical or thermal stress. The path with the instances of damage arranged in series thus constitutes a predetermined breaking point. To this end, WO 2018/122112 A1 specifically describes a method in which the parameters of the laser processing are set such that, on the one hand, easy separability, and, on the other hand, a high fracture strength of the elements, obtained by separation, at the edges arising from the fracturing are achieved.

What is needed in the art is to optimize the edge strength of edges generated by fracturing. What is also needed in the art is that this optimization is able to be adapted to application cases in which different forces or the same forces act on the surfaces of the elements when using the elements produced by separation.

### SUMMARY OF THE INVENTION

The present invention relates to a method for the laser-assisted separation of workpieces composed of brittle-hard materials, such as in particular composed of glass or glass ceramic, and to elements which are producible by the method

Accordingly, a method for dividing workpieces into elements is provided, in which
a workpiece composed of brittle-hard material is provided and
a pulsed laser beam of an ultrashort pulse laser is directed onto the workpiece, wherein
the wavelength of the laser beam and the material of the workpiece are coordinated with one another such that the workpiece is substantially transparent to the laser beam, and wherein
the laser beam is focused to a focus which is elongate in a beam direction and which at least partially lies within the workpiece, wherein
the intensity of the laser beam and the extent of the focus are so great that the laser beam leaves behind filamentary damage in the workpiece, and wherein
a multiplicity of such instances of filamentary damage are introduced next to one another along a path, wherein
the instances of filamentary damage extend from that surface of the workpiece at which the laser beam enters to the opposite surface of the workpiece at which the laser beam exits again, and wherein
the workpiece is separated along the path, such that at least two elements are obtained as a result of the separation, said elements each having two opposite surfaces and an edge surface which is formed by the separation and which connects the two opposite surfaces, wherein
when introducing the instances of filamentary damage, the distance between adjacent instances of filamentary damage at least in one portion of the path is selected such that one of the following conditions is met:
   (i) the difference in terms of magnitude between the characteristic fracture strengths of the element upon bending in opposite directions in this portion is at most 10 MPa, optionally at most 5 MPa, particularly optionally at most 3 MPa,
   (ii) the difference in terms of magnitude between the characteristic fracture strengths of the element upon bending in opposite directions in this portion is at least 30 MPa, optionally at least 40 MPa. The separation along the path is optionally effected by exertion of a mechanical stress.

The present invention is based on the surprising realization that the filamentation makes it possible for there to be different fracture strengths at the edges, depending on the direction in which the element is bent or which of the two opposite sides of the element is placed under tensile stress during the bending. In this case, the two sides of the element differ to the extent that the laser beam enters on one side of the workpiece and exits again on the other side. Although the filaments pass through the workpiece and, in this respect, also generally resemble the transitions of the edge surface into the side surfaces, a considerable strength difference can result in the case of bending in opposite directions. Furthermore, it is surprising that this difference can be influenced in a simple manner by the distance between the instances of filamentary damage, which is also referred to below as pitch, and be set in a precisely reproducible manner. Other parameters in the laser processing, such as the diameter of the laser beam, the pulse duration and the pulse energy, can also influence the strength, but not substantially in such a way that the strengths of the opposite edges can be changed relative to one another in a simple manner. A shortening of the pulse duration, a low number of pulses within a burst, and a smaller overall energy of the burst can thus increase the strength overall, but these changes leave differences in the edge strengths substantially unaffected. Although the optical setup, which for instance includes the focal length of the focusing optical element, can cause different strengths, it cannot be changed easily during the process.

The method can be used to produce an element composed of brittle-hard material having two opposite surfaces and an edge surface which connects the two opposite surfaces, wherein the edge surface is in the form of a fracture surface, and wherein the fracture surface has a multiplicity of instances of filamentary damage, wherein the instances of filamentary damage reach from one edge, which forms the transition between the edge surface and a surface, as far as the opposite edge, wherein the instances of filamentary damage run at regular, invariable distances and parallel to one another at least in one portion, and wherein one of the following features is in turn specified for the fracture strength of the element at the edge surface in the form of a fracture surface:
(i) the difference in terms of magnitude between the characteristic fracture strengths of the element upon bending in opposite directions in this portion is at most 10 MPa, optionally at most 5 MPa, optionally at most 3 MPa,
(ii) the difference in terms of magnitude between the characteristic fracture strengths of the element upon bending in opposite directions in this portion is at least 30 MPa, optionally at least 40 MPa. Here, the characteristic fracture strengths result in the customary manner from the Weibull distributions when ascertaining the fracture stresses in bending tests. Here, the characteristic fracture strength is that stress on the element surface under tensile load at which the probability of fracture Pf is 63.2%. A further, alternative or additional feature, according to which the difference in terms of magnitude between the edge strengths scales with the thickness, is discussed below.

A setting of the fracture strengths, such that either a very similar fracture strength is set at both surfaces or a very different fracture strength of both surfaces is set, can be achieved in particular by setting a distance between the instances of filamentary damage in the range from 1 μm to 16 μm, optionally in the range from 1 μm to 10 μm, optionally in the range from 2 μm to 8 μm, optionally in the range from 3 μm to 7 μm.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a laser processing apparatus;

FIG. 2 shows a plan view of a workpiece processed with the apparatus;

FIG. 3 shows a test apparatus for testing the fracture strength with an element composed of brittle-hard material as sample;

FIG. 4 shows a graph with double-logarithmically plotted measured values of the fracture stress as a function of the probability of failure for the bending of elements with a tensile stress on the light exit side;

FIG. 5 shows the associated Weibull distribution calculated therefrom with the B10 value;

FIG. 6 shows, analogously to FIG. 4, a graph with double-logarithmically plotted measured values of the fracture stress as a function of the probability of failure for the bending of elements with a tensile stress on the light entry side;

FIG. 7 shows, analogously to FIG. 5, the associated Weibull distribution calculated therefrom with the B10 value;

FIG. 8 shows measured values of the fracture strength of glass samples before and after optimization of general influencing variables on the strength;

FIG. 9 shows an element in the form of a rolled-up glass ribbon;

FIG. 10 shows an element with an edge surface having varying distance between the instances of filamentary damage;

FIG. 11 and FIG. 12 show bent elements;

FIG. 13 shows a lens producible by the method;

FIG. 14 shows a tube portion producible by the method; and

FIG. 15 shows a light micrograph of the edge surface of a plate-like element produced by the method.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

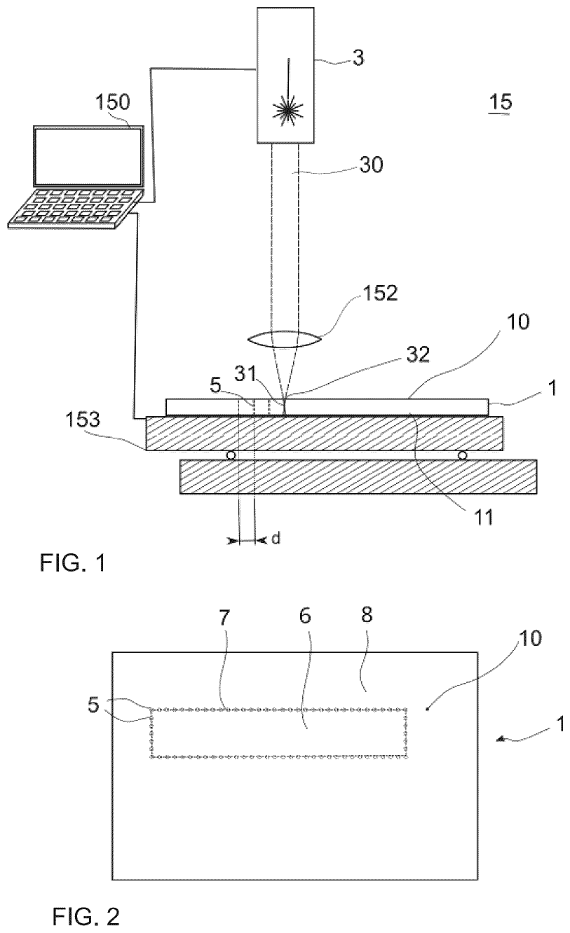

FIG. 1 schematically shows a laser processing apparatus 15 which can be used to carry out the method according to the present disclosure. The apparatus includes an ultrashort pulse laser 3, a focusing device 152 for focusing the laser beam 30 that can be emitted by the ultrashort pulse laser 3, a movement device 153 and a control device 150. The movement device 153 is used to move the workpiece 1 relative to the laser beam 30, such that the position of the point of incidence 32 of the laser beam 30 can be positioned on the surface 10 of the workpiece 1. The movement device 153, as well as the ultrashort pulse laser 3, is actuated by the control device 150. This makes it possible for the time at which a laser pulse or burst of laser pulses is emitted and the position of the point of incidence 32 to be set by the computer of the control device 150, and this makes it possible for a determined pattern of the instances of filamentary damage 5 introduced into the workpiece 1 by the laser beam 30 to be generated. The focusing device 152 is specifically designed to generate an elongate focus 31 in the workpiece 1. In particular, the intensity and shape of the focus 31 are set such that the instances of filamentary damage 5 extend from that surface 10 of the workpiece 1 at which the laser beam 30 enters to the opposite surface 11 of the workpiece 1 at which the laser beam 30 exits again. In general, the power for achieving a non-linear interaction in the material of the workpiece 1 should be at least 10¹³ W/cm². According to an optional embodiment, such an elongate focus 31 with sufficient power can be achieved by way of a focusing device 152 in the form of a lens with a sufficiently high spherical aberration. In the case of such an arrangement, a beam intensity which varies along the focus is also achieved. This is favorable for being able to use variation of the pitch to influence the fracture strengths of the surfaces or of the delimiting edges with respect to the fracture surface. To this end, according to one embodiment of the method, provision is made, without restriction to a specific focusing element, for a focal line or an elongate focus to be generated from the laser beam 30 by beam shaping, wherein an intensity of 10¹³ W/cm² is exceeded along the focal line, wherein the maximum value of the intensity deviates by at least 10%, optionally 20%, optionally 25%, from the average value of the intensity along the focal line.

Due to the aberration, the focus is lengthened on account of the caustic deformation thus produced. There are also other possibilities for generating an elongate focus. Here, mention should be made in particular of an axicon. However, it is assumed that the settability or more generally the influenceability of the fracture strengths of both surfaces 10, 11 is specifically brought about by the intensity distribution in a caustic or aberrated focus, such as can be generated by a lens with a spherical aberration. According to an optional setup, which was also used in the exemplary embodiments described below, a laser beam 10 with a beam diameter of approximately 10 mm was used. The focal length of the lens with the spherical aberration was 16 mm. In general, without restriction to specific exemplary embodiments, option is given to laser wavelengths in the range from 1000 nm to 1100 nm. The pulse duration is optionally at most 20 ps. Use was even made of pulse durations below 1 ps for the examples described below. According to another embodiment, the pulse energy is at least 50 μJ, optionally at least 80 μJ. As can be seen, adjoining instances of filamentary damage 5 which run in parallel and which lie at a distance d from one another are introduced into the workpiece 1. The distance d is settable in a simple manner by way of the control device 150 by setting the positions of the workpiece 1 or its relative speed with respect to the laser beam 30 and its repetition rate. As already described above, the distance d can be used to not only set the fracture strength of the edge surfaces of the elements obtained from the workpiece as a whole but also in a targeted manner depending on the bending direction.

Without restriction to the specific example in FIG. 1, the workpieces 1 processed are optionally glass or glass ceramic parts, further optionally in the form of plates or sheets. Glass or glass ceramic as materials for the workpiece afford the advantage of being transparent to laser light in typical wavelength ranges of ultrashort pulse lasers. Typical, frequently used wavelengths are 1030 nm or 1064 nm, or wavelengths achieved with frequency doubling of 532 nm or 515 nm.

The thickness of the workpieces or of the elements produced therefrom optionally lies in a range from 20 μm to 2 mm, optionally 100 μm to 1 mm, in particular 200 μm to 900 μm. Here, it has been shown that, when setting the distance between the instances of filamentary damage 5 to generate a high difference between the characteristic fracture strength, this difference scales in terms of magnitude with the thickness of the workpiece 1. To this end, provision is made in one embodiment for the difference in terms of magnitude between the characteristic fracture strengths of the two opposite surfaces 10, 11 or of the edges on the two surfaces to be scaled with a factor d*π/3. In particular, provision is made here for a difference in terms of magnitude between the fracture strengths upon bending of the element in opposite directions of at least 30 MPa*d[mm]*π/3 to be obtained in the case of workpiece thicknesses of at least 400 μm by setting of the distance between the instances of filamentary damage. The factor d*π/3 is dimensionless, the thickness in millimeters being used as the number for d. Accordingly, in the case of a 0.5 mm thick workpiece 1, a difference between the characteristic fracture strength of the surfaces 10, 11 of at least 30 MPa*0.5*π/3=15.7 MPa can be obtained. With a similar distance between the instances of filamentary damage 5, a difference of at least 30 MPa*1*π/3=31.4 MPa would then be generated in the case of a 1 mm thick workpiece 1. Optionally, the difference is even at least 40 MPa*d[mm]*π/3, or even 50 MPa*d[mm]*π/3. This embodiment in which the difference between the fracture strengths scales with the thickness of the workpiece 1 is as an alternative or in addition to the embodiment in which the difference in terms of magnitude between the characteristic fracture strengths of the element 6, 8 upon bending in opposite directions in this portion is at least 30 MPa, optionally at least 40 MPa.

However, according to one development, the difference between the fracture strength of the surfaces or between the edge strengths of the edges 131, 132 delimiting the surfaces 10, 11 does also have an upper limit. Optionally, the difference in terms of magnitude is not more than 200 MPa, optionally not more than 150 MPa, particularly optionally not more than 100 MPa. The reason for this is that although brittle-hard materials, such as the optional materials glass and glass ceramic, typically have a compressive strength that is higher by approximately a factor of 10 compared with the tensile strength, given a sufficiently great difference the fracture strength can then also become relevant in relation to pressure and come into the order of magnitude of the fracture strength in relation to tensile stress.

FIG. 2 shows a plan view of a workpiece 1 processed with the apparatus 15. By way of example, here the instances of filamentary damage 5 were introduced along a closed path 7 illustrated in the form of a dashed line. The path 7 subdivides the workpiece 1 into two elements 6, 8, which are, however, still connected to one another in the processing state in FIG. 2. As a result of exertion of a mechanical stress, the elements 6, 8 can then be separated by fracturing of the predetermined breaking point formed by the instances of filamentary damage 5. The illustration in FIG. 2 is purely schematic. In order to, for example, obtain a rectangular element 6, it may be easier to provide a plurality of paths 7 which completely cross the workpiece 1 instead of one closed path, in order to thus facilitate the separation.

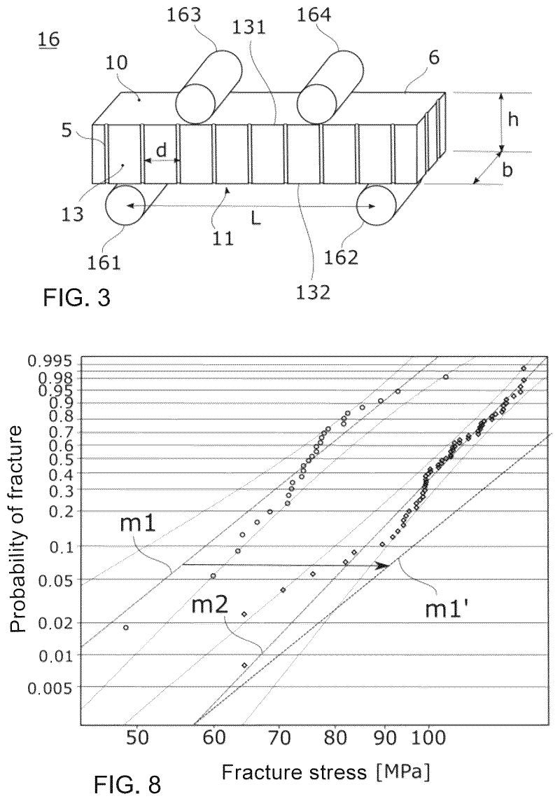

The fracture stresses can be determined in particular by way of a four-point bending measurement. FIG. 3 shows a measuring apparatus 16 for such a four-point bending measurement and an element 6 composed of brittle material which is produced by the method according to the present invention. If the element 6 is too large for the test apparatus 16, it is generally more expedient to cut samples out of the element 6 and examine them. As can be seen, the element 6 or the sample produced therefrom is placed onto two supports 161, 162 such that the support points are located at a distance L relative to one another. Two further supports 163, 164 are placed onto the opposite side 10 of the element 6 at an equal distance from the center position between the supports 161, 162. A force is then exerted on the supports, such that the element 6 is bent. In the illustrated configuration, the element 6 is bent around the side 10, and a tensile stress is exerted on the opposite side 11. The bending force is increased until the element 6 or the sample fractures. Generally speaking, the element fractures with a crack proceeding from the edge surface 13, since the strength of the edge surface 13, in particular at the respective edge 131, 132 under tensile stress, is significantly lower than the strength at the surfaces 10, 11. Here, the following applies to the fracture stress σ:

$$σ = \frac{3 \cdot {F}_{max}}{b \cdot {h}^{2}} \cdot \frac{{l}_{a} - {l}_{b}}{2}$$

In this formula, lₐ represents the distance L between the supports 161, 162, and l_{b} represents the distance between the supports 163, 164. The width b and the height h of the element 6 are labeled in FIG. 3. The instances of filamentary damage 5 which reach from a surface 10 as far as the opposite surface 11 are also illustrated. In other words, the instances of filamentary damage 5 reach from an edge 131 as far as the opposite edge 132 and run at regular, optionally invariable, distances and parallel to one another. The instances of filamentary damage 5 may be formed in particular in the form of thin channels in the workpiece 1. As a result of the separation of the workpiece 1, the instances of damage 5 then have the shape of half-open channels or grooves, or elongate depressions, in the edge surface 13. The distance between the instances of damage can be selected such that according to one embodiment the fracture strengths for the bending around the surface 10 and around the surface 11 at most differ slightly. Optionally, the difference is at most 5 MPa, optionally at most 3 MPa. In this case, it has been shown that there are normally differences in the fracture strength between the bending load of the surface 10, 11 at which the laser beam 30 enters and the bending load of the surface 11, 10 at which the laser beam 30 exits again. According to one embodiment, it is furthermore provided that, when introducing the instances of filamentary damage 5, the distance between adjacent instances of filamentary damage 5 at least in one portion of the path 7 is selected such that at least one of the following conditions is met:
(i) the B10 value of the Weibull distribution of the fracture strengths upon bending of the element 6, 8 is at least 60 MPa, optionally at least 70 MPa, for the tensile stresses on both opposite surfaces 10, 11,
(ii) the characteristic fracture strength value of the Weibull distribution upon bending of the element 6, 8 is at least 80 MPa, optionally at least 90 MPa, optionally at least 100 MPa, for the tensile stress on both opposite surfaces,
(iii) the difference in terms of magnitude between the B10 values of the Weibull distribution of the fracture strengths upon bending of the element 6, 8 in opposite directions is either at most 5 MPa, optionally at most 3 MPa, or at least 30 MPa, optionally at least 40 MPa, or even at least 50 MPa. The B10 value refers to the stress at which statistically 10% of the samples are fractured.

These aforementioned features of the elements produced by the method may also be present independently of or as an alternative to or in addition to the conditions that the difference in terms of magnitude between the characteristic fracture strengths of the element 6, 8 upon bending in opposite directions in the mentioned portion is at most 5 MPa, optionally at most 3 MPa.

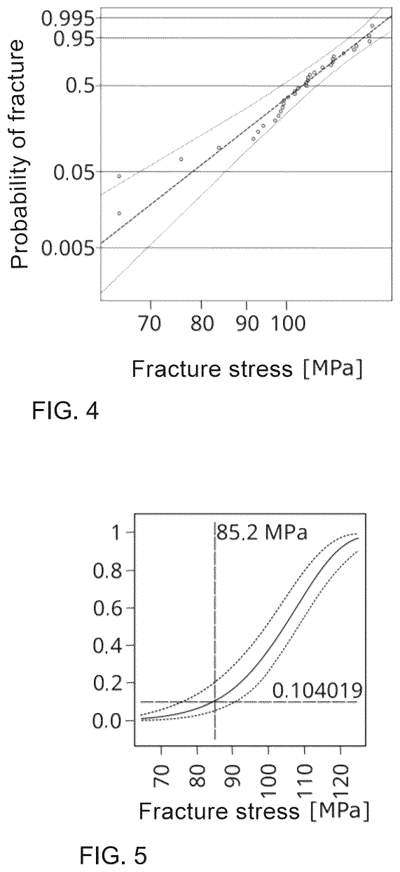

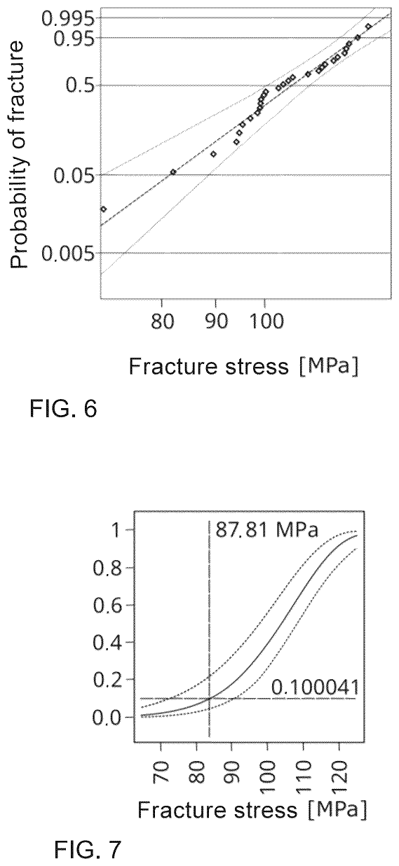

One example in which the above-mentioned features with regard to a low difference in the B10 value are met is shown below on the basis of FIG. 4 to FIG. 7. These measurements were performed after optimization of the process parameters pulse duration, burst number and burst energy with regard to general strength and of the pitch for harmonization of the strengths of the front and rear sides. The pitch was 4.5 μm for all the samples. FIG. 4 shows a graph with measured values of the fracture stress as a function of the probability of failure for the bending of elements which were loaded with a tensile stress on the light exit side, and FIG. 5 shows the associated Weibull distribution calculated from the data with the B10 value. FIG. 6 shows, analogously to FIG. 4, a graph with measured values of the fracture stress as a function of the probability of failure, but here for the bending of elements with a tensile stress on the light entry side, and FIG. 7, analogously to FIG. 5, shows the associated Weibull distribution with the B10 value. The samples used were elements 6 in the form of glass sheets composed of N-SF6 dense flint glass with a thickness of 0.7 mm.

The B10 values are 85.2 MPa for the light exit surface (in the configuration according to FIG. 1, i.e. the surface 11) and 87.81 MPa for the light entry surface (in the configuration according to FIG. 1, i.e. the surface 10) and thus differ in magnitude by less than 3 MPa. The B10 values are particularly important when it comes to an overall low probability of failure.

According to a further embodiment, it is also possible, as already described above, for a particularly high difference in the B10 values between the fracture strengths of the two surfaces 10, 11, or of the corresponding edges 131, 132, to be obtained. Specifically, the setting of a suitable pitch makes it possible to achieve a difference of at least 30 MPa in terms of magnitude. In this respect, in two exemplary embodiments, an N-SF6 glass sheet similar to in the examples in FIG. 4 to FIG. 7 was processed, with the following parameters and measured values of the fracture strength in Table 1 which follows:

| Parameter: | Example 1 | | Example 2 | |
|---|---|---|---|---|
| Pulse duration: | 1 | ps | 0.35 | ps |
| Burst energy: | 267.16 | μJ | 143 | μJ |
| Pitch: | 2 | μm | 7 | μm |
| Number of pulses per burst: | 4 | | 3 | |
| Characteristic fracture strength of | 79.90 | MPa | 124.4 | MPa |
| beam entry surface: | | | | |
| Characteristic fracture strength of | 128.03 | MPa | 79.8 | MPa |
| beam exit surface: | | | | |
| B10 value of beam entry surface: | 62.64 | MPa | 104.9 | MPa |
| B10 value of beam exit surface: | 113.06 | MPa | 68.6 | MPa |

| | | |
|---|---|---|
| Weibull modulus of beam entry | 9.7 | 13.3 |
| surface: | | |
| Weibull modulus of beam exit surface: | 18.2 | 15.3 |

In Example 1, the difference in terms of magnitude between the fracture strengths upon bending in opposite directions is accordingly 128.03 MPa−79.90 MPa=48.13 MPa. The difference in terms of magnitude between the B10 values of 113.06 MPa−62.64 MPa=50.42 MPa is also considerably higher than 30 MPa, just as the difference between the characteristic fracture strengths is greater than 40 MPa. Due to the selected laser parameters, the glass element is accordingly considerably stronger in relation to tensile stresses that occur on the surface 10, 11, which forms the light exit surface during the processing, than on the opposite surface. Example 2 shows that the ratios of the fracture strengths at the entry and exit surfaces can also be reversed. In contrast to Example 1, the light entry surface has the higher strength in Example 2. The differences in terms of magnitude between the characteristic strengths and B10 values are in this case 44.5 MPa and 36.3 MPa, similar to the values from Example 1.

In general, the fracture strengths under tensile stress can be influenced as follows. The fracture strength of the surface 10, 11 which forms the light exit surface, that is to say the surface 11 in the example in FIG. 1, can be increased by reducing the pitch, that is to say the distance d between the instances of filamentary damage 5. Conversely, the fracture strength of the surface 10, 11 which forms the light entry surface, that is to say the surface 10 in the example in FIG. 1, can be increased by increasing the pitch. Accordingly, provision is made in a development of the method for the setting of the fracture strength of the element 6, 8 to include at least one of the steps:
increasing the fracture strength of the surface 11, 10 at which the laser beam 30 exits by increasing the distance between the instances of filamentary damage 5,
increasing the fracture strength of the surface 10, 11 at which the laser beam 30 enters by reducing the distance between the instances of filamentary damage 5.

These steps can be effected during the laser processing on a workpiece 1, in order to, for example, generate different portions of the edge surface 13 having differently distributed strengths, or in a setting procedure prior to the processing of the workpieces 1.

If, according to the method described here, harmonization of the fracture strengths of the two surfaces is performed by changing the distance between the instances of filamentary damage, it is additionally also possible to achieve an improvement in the fracture strength overall, independently of which of the surfaces 10, 11 is placed under tensile stress. In this respect, FIG. 8 shows two measurement series. These measurement series were also carried out on samples of a 0.7 mm thick N-SF6 dense flint glass. In this case, the measured values labeled with circular symbols represent the starting point. Here, the strength of the glass samples was measured at the sample surface 10 at which the laser beam entered. The measured values labeled with diamond symbols were recorded after the distance between the instances of filamentary damage 5 was changed such that harmonization of the characteristic fracture strengths on the laser side (surface 10 according to FIG. 1) and the rear side (surface 11 according to FIG. 1) was obtained. In particular, the following parameters were used during the processing: Prior to optimization, a pulse duration of 12 ps, a pitch of 4 μm, a burst operation with 3 laser pulses per burst and a burst energy of 320 μJ was used. After optimization, a pulse duration of 350 fs, a pitch of 4.5 μm, a burst operation with two laser pulses per burst and a burst energy of 161 μJ was used. The optical setup was otherwise identical in both cases. After setting of the distance between the instances of filamentary damage 5, the two measurement series lie on top of one another so well that the series are not distinguishable. Here, the harmonization of the characteristic values of the fracture strength also contributed to the obtained increase in strength of more than 30% overall. In the illustration in FIG. 8, the moduli of the Weibull distributions represent the gradients of the depicted straight lines. The calculated Weibull distributions of the measurement series prior to and after setting of similar fracture strengths are depicted as straight lines m1 and m2, the gradient of which denotes the Weibull modulus. For clarification, the straight line of gradient m1 is depicted again with a parallel shift and labeled m1′. The increase in the Weibull modulus is clearly apparent from the comparison of straight lines m2 and m1′. In this respect, without restriction to the examples described, provision is made in one development for the distance between the instances of filamentary damage 5 to be selected such that the Weibull modulus for the fracture strength of both surfaces 10, 11 is greater than 6, optionally greater than 7, particularly optionally greater than 8.

Examples in which a large difference in the fracture strengths between the two opposite surfaces 10, 11 of a glass element was set by changing the laser parameters are shown below. The glass element has a refractive index of 1.8 and includes the following components (in % by weight):

| | |
|---|---|
| SiO₂ | 28.2 |
| Na₂O | 9.6 |
| K₂O | 5.3 |
| CaO | 0.9 |
| BaO | 14.4 |
| TiO₂ | 25.1 |
| Nb₂O₅ | 17.5 |

The laser parameters and the measured strength values are reported in the following table.

TABLE
Exemplary embodiments: Dependence of the
fracture strengths on laser parameters

| Example | 1 | 2 |
|---|---|---|
| Pulse duration in ps | 0.35 | 0.35 |
| Burst repetition frequency in kHz | 100 | 100 |
| Power level in % | 80 | 80 |
| Pitch in μm | 2 | 7 |
| Number of pulses per burst | 2 | 2 |
| Burst energy | 143 | 143 |
| Characteristic strength of laser | 90.8 | 134.1 |
| entry surface [MPa] | | |
| Characteristic strength of laser | 109 | 103 |
| exit surface [MPa] | | |
| Strength difference [MPa] | 18.2 | 31.1 |

Without restriction to the specific examples, pulse durations of at most 20 ps, optionally at most 10 ps, in particular at most 5 ps, optionally even below 1 ps, are generally optional for the method according to the present disclosure. The number of pulses within a burst optionally lies between 2 and 6.

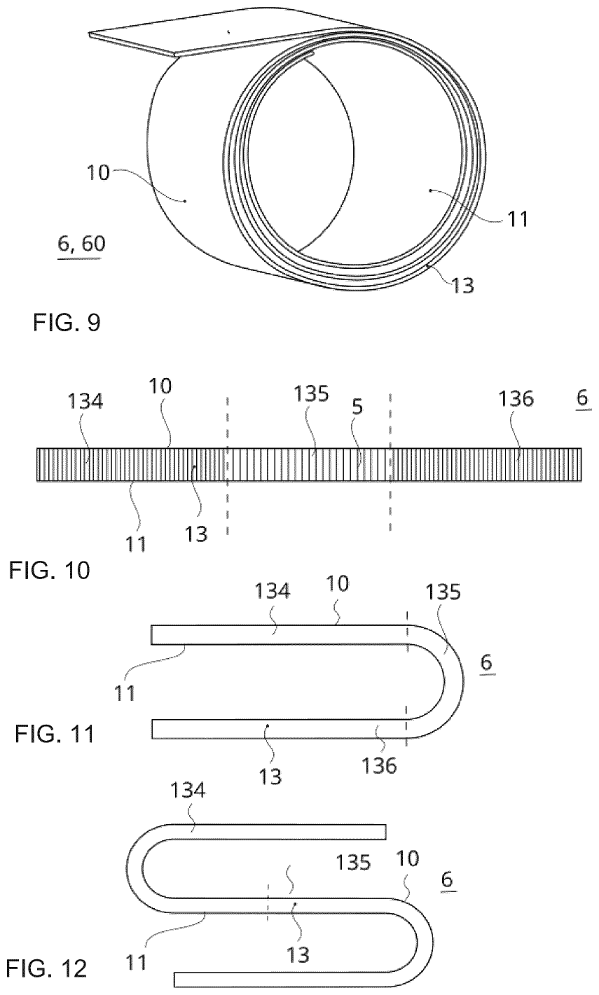

As is apparent from the table, the laser parameters are identical apart from the pitch, that is to say the distance between the instances of filamentary damage 5. In Example 1, the pitch is 2 μm, whereas a pitch of 7 μm was set in Example 2. Here, it has been shown that the change of the pitch from 2 μm to 7 μm has the effect that one of the surfaces, namely the surface 10 at which the laser light enters, gains in strength considerably, whereas the opposite surface 11 suffers a slight loss in fracture strength. As a result, the difference in terms of magnitude between the characteristic fracture strengths of the element 6, 8 upon bending in opposite directions, that is to say upon loading of both surfaces with a tensile stress, increases to above 30 MPa. Such an effect may be desirable if the loadings of the element 6, 8 are also asymmetrical during use. In general, according to optional embodiments, an element producible by the method may be a lens, in particular with optical structuring for information overlay, as is desired for what are known as “Augmented Reality” applications. Further applications are the production of optical elements, such as eyepieces or constituent parts thereof, or the cutting of glass ribbons, which can then be rolled up, and glass tubes. A cover glass for a mobile display or a glass ceramic hob can also be produced by cutting. In some applications, a symmetrical loading capacity in both bending directions may be advantageous, whereas an asymmetrical loading capacity may be advantageous in other applications, as explained on the basis of the above examples in the table. In the case of a glass ceramic hob, during use a compressive loading is for example typically exerted from above, or on the surface which is the useful side, such that tensile stresses are produced on the lower side. Provision is therefore made according to one embodiment for the glass ceramic hob to have, on the surface 11 which forms the lower side, a fracture strength in relation to tensile stress that is at least 30 MPa higher than the fracture strength of the surface which forms the upper side. By contrast, in the case of a rolled-up glass ribbon, the surface which faces outward during the rolling-up operation may have the higher fracture strength in relation to tensile stress. Such an example is shown in FIG. 9. The element 6 in the form of a glass ribbon 60 is produced in particular in a continuous hot forming process. Such a process may be a floating process or a drawing process, for instance a down-draw method or an overflow fusion method. In this case, the original glass ribbon forms the workpiece 1. The thickened borders that are present as a result of the process can then be separated from said workpiece by the method described here, such that the longitudinal edges of the glass ribbon 60 are again edge surfaces 13, in the form of fracture edges, having instances of filamentary damage 5 (not illustrated on account of the scale in FIG. 9). After separation of a sufficiently long portion, this separated glass ribbon 60 can then be rolled up into a roll in a space-saving manner as shown in FIG. 9. In the example shown, the surface 10 of the roll faces outward and is convexly bent, such that this surface 10 is subjected to a tensile stress. The distances between the instances of filamentary damage can therefore be set in such a way that the outer side, that is to say the surface 10, has a higher characteristic fracture stress than the surface 11 which forms the inner side. Accordingly, provision is made in one development of the method for an element 6 in the form of a glass ribbon 60 to be produced by separation of borders of a raw glass ribbon, wherein the separation of the borders includes the introduction of instances of filamentary damage 5 along paths 7 which extend parallel to the longitudinal edges of the raw glass ribbon and the fracturing of the borders, and wherein the glass ribbon 60 is rolled up, wherein the distances between the instances of filamentary damage 5 are selected such that the surface 10 which forms the outer side of the roll of the glass ribbon has a higher fracture strength, in particular a fracture strength which is at least 30 MPa higher, than the surface 11 which forms the inner side of the roll.

A further advantageous application of the method and glass elements produced thereby are slides, or object carriers, for protein microanalysis. These object carriers are glass elements which are coated on one side, wherein the coating includes or constitutes a biochemically active layer for immobilizing proteins, such as antibodies, enzymes or DANN molecules. Corresponding glass elements are sold under the trade name Nexterion. The method described here can also be used to separate these glass elements 6 from a larger glass plate as workpiece 1 in such a way that the surface 10, 11 loaded during the processing has a higher fracture strength than the opposite surface 11, 10. However, where necessary, both surfaces may also be formed so as to be able to be subjected to similar loads.

By contrast, in the case of an eyepiece or a cover glass for a display, tensile loadings may occur in both directions, such that here a fracture strength which is as high and similar as possible may be desired on both surfaces, for instance according to the example in FIG. 8, in which thus the difference in terms of magnitude between the fracture strengths is at most 10 MPa, optionally at most 5 MPa, in particular at most 3 MPa.

FIG. 10 shows an example of an element 6 according to yet another embodiment. FIG. 10 shows an element with an edge surface having varying distance between the instances of filamentary damage 5. This example is based on a development of the method in which instances of filamentary damage 5 are introduced at different distances along certain portions of the path 7, such that, after the separation, an element 6 is obtained which has an edge surface 13 having a plurality of portions, in the example the portions 134, 135, 136, which differ with regard to the distance between the instances of filamentary damage 5 and the characteristic fracture strengths of the surfaces 10, 11 upon bending of the element 6 in the respective portion 134, 135, 136. In the illustrated example, the distance between the instances of filamentary damage 5 in the middle portion 135 of the edge surface 13 is greater than in the adjoining portions 134, 136.

If Example 2 in the table or corresponding embodiments of the filamentation are taken as a basis, there is then the possibility of providing one of the surfaces 10, 11, or generally the edges at the transition to the edge surface 13, with a higher fracture strength in relation to tensile stress in one or more portions. This is advantageous if the element 6 is used in such a way as to be intermittently or permanently bent in a certain direction. In this respect, FIG. 11 shows an example of a bent element 6. The edge surface 13 of the element 6 may be structured analogously to the example in FIG. 10. Accordingly, three portions 134, 135, 136 are provided. Portion 135 is structured such that the surface 10 has an increased fracture strength in this portion. The element 6 is then bent in this portion, such that the surface 10 is convexly curved and accordingly is placed under tensile stress. By way of example, such an embodiment may be provided for a bendable display, for example for a mobile device.

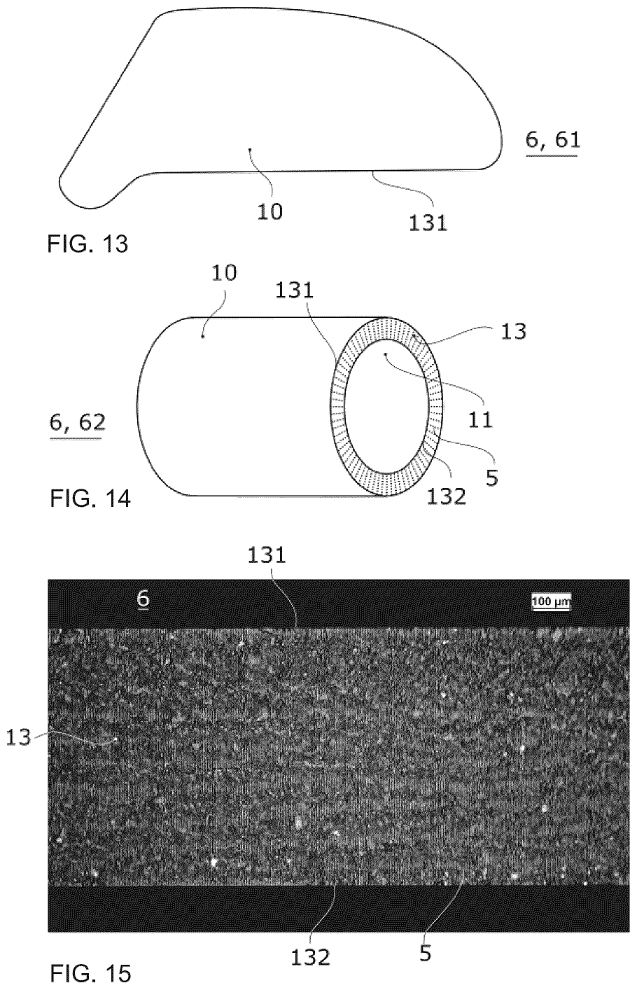

FIG. 12 shows an example of a further embodiment. In this embodiment, at least two portions 134, 135 of the edge surface 13 are provided, which are in turn structured differently with regard to the distance between the instances of filamentary damage. In this case, the element 6 is bent in one direction in the region of the portion 134 of the edge surface 13 and in the opposite direction in the region of the portion 135. Here, the distance between the instances of filamentary damage in the portions is selected such that the respectively outwardly facing, or convexly curved, surface 10, 11, which is thus locally under tensile stress, in the region of the portion has a higher characteristic fracture strength, in particular a characteristic fracture strength which is at least 30 MPa higher, than the other surface 11, 10. A factor common to the embodiments forming the basis for the examples in FIG. 11 and FIG. 12 is that the edge surface 13 of the element 6 again has a plurality of portions 134, 135 which differ with regard to the distance between the instances of filamentary damage 5 and the characteristic fracture strengths of the surfaces 10, 11 upon bending of the element 6 in the respective portion 134, 135, 136, wherein the element 6 is bent, or mounted under bending, in at least one of the portions in such a way that the surface 10, 11 having the higher characteristic fracture strength is under tensile stress on account of the bending. FIG. 13 shows an optional exemplary application of the method described herein. The method is particularly suitable for separating an element 6, which is usable as a lens 61, from a workpiece. In this case, the glass element 6 does not have to have a lens effect, but can particularly optionally have an internal structuring and/or a structured or non-structured surface coating, by way of which information can be made visible and displayed for the user. Such a lens can particularly be used in eyewear for presenting augmented reality information.

The exemplary embodiments shown hitherto are based on plate-like workpieces 1. However, it is also possible to process tubular or container-like workpieces. In this respect, FIG. 14 shows an element 6 in the form of a tube portion 62 producible by the method. This was produced by virtue of instances of filamentary damage 5 being introduced along a ring-like, closed path 7 into a tube as workpiece 1 composed of brittle material and then the tube portion 62 being separated. In this case, the opposite surfaces 10, 11 are then the outer and inner surfaces of the tube portion 62, and the edge surface 13 forms an end surface of the tube. In this embodiment, it is generally advantageous if the distance between the instances of filamentary damage 5 is selected such that the outer surface, here the surface 10, has a higher fracture strength in relation to tensile stress than the inner surface. Here, the distance between the instances of filamentary damage is the distance therebetween on the outer surface, since this represents the pitch set. In this case, strictly speaking the filaments also do not run in parallel, but rather taper in a radial direction toward the center axis of the tube portion 62.

FIG. 15 lastly shows a light micrograph of the edge surface 13 of a plate-like element 6 produced by the method. As can be seen, the edge surface 13 appears as a fracture surface with fine lines running parallel to one another from edge 131 to edge 132 and representing the instances of filamentary damage 5. In this case, the instances of filamentary damage 5 extend from edge to edge, even if they are potentially or partially interrupted by the fracture. In any case, it becomes apparent from the structure of the edge surface 13 that filaments passing from surface 10 to surface 11 were actually introduced, unlike in the case for instance of what is known as stealth dicing, in which the modifications or filaments lie only within the material, i.e. relate only to limited regions of the substrate material. As a result of the processing according to the present disclosure, a fracture surface of homogeneous appearance without smooth fracture is thus obtained. The surface proportion of smooth fracture regions is at least negligible. Without restriction to the illustrated example, the edge surface 13 is therefore in the form of a fracture surface with a surface proportion of smooth fracture regions of less than 10%, optionally less than 5%.

### LIST OF REFERENCE SIGNS

| | |
|---|---|
| 1 | Workpiece |
| 3 | Ultrashort pulse laser |
| 5 | Filamentary damage |
| 6, 8 | Element composed of brittle-hard |
| | material |
| 7 | Path |
| 10, 11 | Surfaces of 1 |
| 13 | Edge surface |
| 15 | Laser processing apparatus |
| 16 | Test apparatus |
| 30 | Laser beam |
| 31 | Focus |
| 32 | Point of incidence of 30 on 10, 11 |
| 60 | Glass ribbon |
| 61 | Lens |
| 62 | Tube portion |
| 131, 132 | Edge |
| 134, 135, | Portions of the edge surface 13 |
| 136 | |
| 150 | Control device |
| 152 | Focusing device |
| 153 | Movement device |
| 161, 162, | Support |
| 163, 164 | |

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for dividing a workpiece into a plurality of elements, the method comprising the steps of:
providing the workpiece which is composed of a material which is brittle-hard;
directing a laser beam—which is pulsed—of an ultrashort pulse laser onto the workpiece;
coordinating a wavelength of the laser beam and the material of the workpiece with one another such that the workpiece is substantially transparent to the laser beam;
focusing the laser beam to a focus which is elongate in a beam direction and which at least partially lies within the workpiece, wherein an intensity of the laser beam and an extent of the focus are so great that the laser beam leaves behind a first filamentary damage in the workpiece;
introducing a plurality of instances of filamentary damage—which includes the first filamentary damage—next to one another along a path, wherein the plurality of instances of filamentary damage extend from a first surface of the workpiece at which the laser beam enters to a second surface—which is opposite the first surface—of the workpiece at which the laser beam exits again;
separating the workpiece along the path, such that at least two of the plurality of elements are obtained as a result of the separating, the at least two of the plurality of elements including the first surface, the second surface, and an edge surface which is formed by the separating and which connects the first surface and the second surface;
selecting, when introducing the plurality of instances of filamentary damage, a distance between adjacent ones of the plurality of instances of filamentary damage at least in a portion of the path such that one of the following conditions is met:
(i) a difference in terms of a magnitude between a plurality of characteristic fracture strengths of a respective one of the at least two of the plurality of elements upon bending in opposite directions in the portion of the path is at most 10 MPa;
(ii) a difference in terms of a magnitude between a plurality of characteristic fracture strengths of a respective one of the at least two of the plurality of elements upon bending in opposite directions in the portion of the path is at least 30 MPa; and
(iii) a difference in terms of a magnitude between a plurality of fracture strengths of a respective one of the at least two of the plurality of elements upon bending in opposite directions is at least 30 MPa*d[mm]*π/3.

2. The method according to claim 1, wherein, when introducing the plurality of instances of filamentary damage, the distance between adjacent ones of the plurality of instances of filamentary damage at least in the portion of the path is selected such that at least one of the following conditions is met:
(i) a B10 value of a Weibull distribution of a plurality of fracture strengths upon bending of the respective one of the at least two of the plurality of elements is at least 60 MPa, for a plurality of tensile stresses on both the first surface and the second surface;
(ii) a characteristic fracture strength value of a Weibull distribution upon bending of the respective one of the at least two of the plurality of elements is at least 80 MPa, for a tensile stress on both the first surface and the second surface; and
(iii) a difference in terms of a magnitude between a plurality of B10 values of a Weibull distribution of a plurality of fracture strengths upon bending of the respective one of the at least two of the plurality of elements in opposite directions is either at most 5 MPa or at least 30 MPa.

3. The method according to claim 1, wherein a setting of a fracture strength of the respective one of the at least two of the plurality of elements includes at least one of the following steps:
increasing the fracture strength of the second surface at which the laser beam exits by increasing the distance between adjacent ones of the plurality of instances of filamentary damage; and
increasing the fracture strength of the first surface at which the laser beam enters by reducing the distance between adjacent ones of the plurality of instances of filamentary damage.

4. The method according to claim 1, wherein the distance between adjacent ones of the plurality of instances of filamentary damage is set in a range of 1 μm to 16 μm.

5. The method according to claim 1, wherein a focal line, along which the intensity exceeds 10¹³ W/cm², is generated from the laser beam by beam shaping, wherein a maximum value of the intensity deviates by at least 10% from an average value of the intensity along the focal line.

6. The method according to claim 1, wherein the laser beam is focused by way of a lens with a spherical aberration.

7. The method according to claim 1, wherein the plurality of elements includes a first element and a second element, wherein the first element is a glass ribbon and is produced by separating a plurality of borders of a raw glass ribbon, wherein the separating of the plurality of borders includes (a) introducing the plurality of instances of filamentary damage along a plurality of the path which extend parallel to a plurality of longitudinal edges of the raw glass ribbon and (b) fracturing the plurality of borders, wherein the glass ribbon is rolled up and thereby forms a roll, wherein a plurality of distances between the plurality of instances of filamentary damage are selected such that the first surface—which forms an outer side of the roll of the glass ribbon—has a higher fracture strength than the second surface which forms an inner side of the roll.

8. The method according to claim 1, wherein the plurality of elements includes a first element and a second element, wherein the plurality of instances of filamentary damage are introduced at different distances along certain portions of the path, such that, after the step of separating, the first element is obtained which includes the edge surface having a plurality of portions which differ with regard to a distance between adjacent ones of the plurality of instances of filamentary damage and a plurality of characteristic fracture strengths of the first surface and the second surface upon bending of the first element in a respective one of the plurality of portions of the edge surface.

9. The method according to claim 1, wherein a distance between adjacent ones of the plurality of instances of filamentary damage is set such that a Weibull modulus of a strength distribution of at least one of the first surface and the second surface is greater than 6.

10. The method according to claim 1, wherein the step of separating occurs by exerting a mechanical stress.

11. An element composed of a material which is brittle-hard, the element comprising:
a first surface;
a second surface which is opposite the first surface;
an edge surface which connects the first surface and the second surface, the edge surface being a fracture surface, the fracture surface including a plurality of instances of filamentary damage, which run at regular distances and parallel to one another at least in a first portion of the edge surface;
a first edge, which forms a transition between the edge surface and the first surface or the second surface;
a second edge which is opposite the first edge,
wherein one of the following features is specified for a fracture strength of the element at the edge surface which is formed as the fracture surface:
(i) a difference in terms of a magnitude between a plurality of characteristic fracture strengths of the element upon bending in opposite directions in the first portion of the edge surface is at most 5 MPa;
(ii) a difference in terms of a magnitude between a plurality of characteristic fracture strengths of the element upon bending in opposite directions in the first portion of the edge surface is at least 30 MPa; and
(iii) a difference in terms of a magnitude between a plurality of fracture strengths upon bending of the element in opposite directions is at least 30 MPa*d[mm]*π/3.

12. The element according to claim 11, wherein at least one of the following features is specified for the fracture strength of the element:
(i) a B10 value of a Weibull distribution of the fracture strengths upon bending of the element is at least 60 MPa for a plurality of tensile stresses on both the first surface and the second surface;
(ii) a difference in terms of a magnitude between a plurality of B10 values of a Weibull distribution of a plurality of fracture strengths upon bending of the element in opposite directions is at most 5 MPa.

13. The element according to claim 11, wherein a first distance between the plurality of instances of filamentary damage lies in a range of 1 μm to 16 μm, the regular distances including the first distance.

14. The element according to claim 11, wherein a first distance between the plurality of instances of filamentary damage is such that a Weibull modulus for the fracture strength of the first surface and the second surface is greater than 6, the regular distances including the first distance.

15. The element according to claim 11, wherein the edge surface has a plurality of portions which include the first portion and which differ with regard to a first distance between the plurality of instances of filamentary damage and a plurality of characteristic fracture strengths of the first surface and the second surface upon bending of the element in a respective one of the plurality of portions of the edge surface, the regular distances including the first distance.

16. The element according to claim 15, wherein the element is bent in at least one of the plurality of portions of the edge surface such that the first surface or the second surface having a higher characteristic fracture strength relative to the other of the first surface or the second surface is under a tensile stress on account of the element being bent.

17. The element according to claim 11, wherein the edge surface—which is formed as the fracture surface—has a surface proportion of smooth fracture regions of less than 10%.

18. The element according to claim 11, wherein the element is:
a lens;
an eyepiece or a constituent part of an eyepiece;
a rolled-up glass ribbon;
a cover glass configured for a mobile display;
a glass tube or a container glass;
a glass ceramic hob; or
a glass element which is coated on one side.

19. The element according to claim 18, wherein the glass element has a biochemically active layer for immobilizing proteins, wherein the first surface or the second surface—which is loaded during a processing—has a higher fracture strength than the other of the first surface or the second surface.

20. The element according to claim 11, wherein the element is configured for being produced according to a method for dividing a workpiece into a plurality of the element, the method including the steps of:
providing the workpiece which is composed of the material which is brittle-hard;
directing a laser beam—which is pulsed—of an ultrashort pulse laser onto the workpiece;
coordinating a wavelength of the laser beam and the material of the workpiece with one another such that the workpiece is substantially transparent to the laser beam;
focusing the laser beam to a focus which is elongate in a beam direction and which at least partially lies within the workpiece, wherein an intensity of the laser beam and an extent of the focus are so great that the laser beam leaves behind a first filamentary damage in the workpiece;
introducing the plurality of instances of filamentary damage—which includes the first filamentary damage—next to one another along a path, wherein the plurality of instances of filamentary damage extend from the first surface of the workpiece at which the laser beam enters to the second surface—which is opposite the first surface—of the workpiece at which the laser beam exits again;
separating the workpiece along the path, such that at least two of the plurality of the element are obtained as a result of the separating, the at least two of the plurality of the element including the first surface, the second surface, and the edge surface which is formed by the separating and which connects the first surface and the second surface;
selecting, when introducing the plurality of instances of filamentary damage, a distance between adjacent ones of the plurality of instances of filamentary damage at least in a portion of the path such that one of the following conditions is met:
(i) a difference in terms of a magnitude between a plurality of characteristic fracture strengths of a respective one of the at least two of the plurality of the element upon bending in opposite directions in the portion of the path is at most 10 MPa;
(ii) a difference in terms of a magnitude between a plurality of characteristic fracture strengths of a respective one of the at least two of the plurality of the element upon bending in opposite directions in the portion of the path is at least 30 MPa; and
(iii) a difference in terms of a magnitude between a plurality of fracture strengths of a respective one of the at least two of the plurality of the element upon bending in opposite directions is at least 30 MPa*d[mm]*π/3.
